(19) United States
(12) Patent Application Publication
(10) Pub. No.: US 2025/0350552 A1
(43) Pub. Date: Nov. 13, 2025

(54) INTELLIGENT DEVICE GROUP TAGGING DURING TRANSPORT GATEWAY (TGW) ROUTE RE-ORIGINATION

(71) Applicant: Cisco Technology, Inc., San Jose, CA (US)

(72) Inventors: Satish Kumar Mahadevan, San Ramon, CA (US); Prosenjit Sarkar, Santa Clara, CA (US); Pritam Baruah, Fremont, CA (US); Sourav Sen, San Jose, CA (US)

(21) Appl. No.: 18/659,890

(22) Filed: May 9, 2024

(51) Int. Cl. H04L 45/00; H04L 12/66

(52) U.S. Cl. CPC H04L 45/22; H04L 12/66

(57) ABSTRACT

Techniques for routing in a software-defined wide area network (SD-WAN) are disclosed herein. In some aspects, the techniques described herein relate to configuring, by a routing controller, at least one data traffic route originating from a device of a first group of devices to a first Transport Gateway (TGW) and a gateway hub, tagging the at least one data traffic route with a first identifier associated with the first group of devices to send to the first TGW and to a first set of routers of the hub gateway wherein the at least one data traffic route originates from at least one device of the first group of devices, and sending a tagged data traffic route originating from at least one device of the first group of devices based on the first identifier to the first TGW and the first set of routers of the hub gateway.

### TECHNICAL FIELD

The present invention is directed to the field of computer networking and, more specifically, to utilizing transport gateway route identifiers to filter and direct application traffic through high-speed paths originating from groupings of devices for Software-Defined Wide Area Networks (SD-WANs).

### BACKGROUND

Networks managing cloud-based data traffic often include various types of networks and network devices responsible for transporting individual data packets. The network devices may be utilized to route the data traffic from branch devices and to cloud devices. The data traffic may be routed utilizing networks of different types according to instructions from the branch devices. The different types of networks may include public networks utilized to route the data traffic through the internet, as well as private networks, such as proprietary service-guaranteed networks.

Software-Defined Wide Area Networks (SD-WAN) is an overlay architecture to overcome the drawbacks of traditional WAN that builds secure, unified connectivity over any transport technology (Multiprotocol Label Switching (MPLS), broadband, Long-Term Evolution (LTE), Very Small Aperture Terminal (VSAT), and others).

To address these challenges, Software-Defined WAN (SD-WAN) has emerged as a new technology that provides a more cost-effective, flexible, and scalable approach to WAN management. SD-WAN uses software to abstract the underlying physical network infrastructure and provides a centralized control plane to manage the network. This allows network administrators to dynamically allocate bandwidth to different applications and prioritize traffic based on business needs.

Branch devices may generate instructions utilized to identify preferred networks through which the data traffic may be routed. To accomplish this type of prioritization within the networks, the branch devices may utilize information associated with the different types of networks. Public networks may be associated with relatively lower costs compared to private networks, as well as being associated with nonexistent or limited predetermined customer agreements. Utilizing private networks often requires the performance of complex configurations. However, as amounts of data traffic and cloud utilization grow, customer interest in leveraging private networks for cloud data communication continues to become increasingly important.

Therefore, there is a need for an SD-WAN architecture to achieve different topologies and routing behaviors that intelligently and selectively tag re-originated data traffic routes with the introduction of device group identifiers that are flexible enough to accommodate changes in network traffic patterns.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 is an architecture diagram for an example dedicated Transport Gateway (TGW) architecture of a cloud computing framework (e.g., a topology of a set of TGWs for a respective device group) of an SD-WAN system according to some embodiments.

FIG. 2 is an architecture diagram for an example of shared TGW architecture of a cloud computing framework (e.g., a topology of a shared TGW with inter-device group routing of respective device groups) of an SD-WAN system according to some embodiments.

FIG. 3 is an architecture diagram for an example of shared TGW architecture of a cloud computing framework (e.g., a topology of a shared TGW for both device groups without inter-device group routing) of an SD-WAN system.

FIG. 4 is a flowchart diagram of an example process for selectively sending data traffic routes originating from at least one device of a group of devices to a dedicated transport gateway (TGW) and a gateway hub according to some embodiments.

FIG. 5 is a flowchart diagram of an example process in which a shared TGW is configured with a local configuration that constricts or enables the operation of the TGW use of a specific device group identifier when the TGW learns about a route from a branch router according to some embodiments.

FIG. 6 is a flowchart diagram of an example process in which a shared TGW is configured without a device group identifier to prevent filtering of learned routes by the shared TGW that have been routed by the routing controller according to some embodiments.

FIG. 7 is a flowchart diagram of another example process in which a shared TGW is configured without a device group identifier to prevent filtering of learned routes by the shared TGW that have been routed by the routing controller but is configured to preserve the prior device group identification for reusing in re-originated created routes according to some embodiments.

FIG. 8 shows an example computer architecture for a computing device (or network routing device) capable of executing program components for implementing the functionality described above.

### DESCRIPTION OF EXAMPLE EMBODIMENTS

### Overview

Aspects of the invention are set out in the independent claims and preferred

features are set out in the dependent claims. Features of one aspect may be applied to each aspect alone or in combination with other features.

This disclosure describes techniques for routing re-originated data traffic in device groups with interconnected gateways associated with cloud networks and private networks. An example method includes identifying a route identifier and utilizing the route identifier for grouping and filtering data traffic.

This disclosure describes multiple ways of deploying TGWs that implement a dedicated TGW, a shared TGW with the option to do inter-device group routing, and a shared TGW for all device groups but without the option to do inter-device group routing via the TGW. In an embodiment of the dedicated TGW, each device group has a set of dedicated TGWs that serve only that device group. This allows for better capacity planning and provides better and more deterministic throughput when the traffic volume is high. In an embodiment, for the shared TGW for all device groups, with the option to do inter-device-group routing via the TGW; in this case, the same set of TGWs serve multiple device groups and can route traffic across device groups (for a hub-and-spoke model). This is more cost-effective and works better when the traffic volume is not expected to be very high. In an embodiment, for shared TGW for all device groups, but without the option to do inter-device-group routing via the TGW; in this case, the same set of TGWs serve multiple device groups, but they must not route traffic across device groups. Instead, the devices in each device group will use the TGWs only for accelerated access to the cloud.

In some embodiments, the routing controller will filter routes, and distribute the routes based on identifiers tagged to each route that identifies the data traffic route from an originating device.

In some embodiments, the TGW will have a local implementation that allows for configuring or treating a particular device group based on the data traffic routes that the TGW learns that are originating from each device (e.g., branch router) of the group of devices. In some embodiments, the TGW is configured to implement three options (a) the TGW is configured with a specific device group identification, (b) the TGW is not configured with a device group identification, and (c) the TGW is not configured with a device group identification but is configured to preserve and carry over the received device group identification to the re-originated route device identifier by tagging it with the same identifier.

In some embodiments, the TGW is a dedicated TGW that is configured for specific group identification. The TGW creates a corresponding route, a re-originating route to the device that is tagged with another identifier created by the TGW. In some embodiments, a route is sent from a device in a particular device group, is tagged with a device group route, and is sent to a routing controller. In some embodiments, the routing controller will send the route to others in the device group (from which it originated) or it may send the route in an overlay that is device group agnostic.

In some embodiments, the TGW is a shared TGW and the TGW is not configured with the device group identification. The TGW, in this instance, learns of data traffic routes from a device (e.g., a branch router) in each one of the device groups and from all of the device groups without filtering by a routing controller to the TGW. The TGW based on the learned data traffic route, creates a complementary opposing or corresponding re-originating route and resets the device group identification tag in the re-originated route. As a result, the device group re-originated the route because it now has a different tag than the originated route from the device group, it will not be subject to the same filtering as the originated route identification is subjected to. The re-originated routes may be distributed by the TGW to devices in all device groups. This will cause the shared TGW to attract data traffic and act as a gateway for routes from all the device groups, and the gateway may be considered a gateway for inter-device group traffic that allows similar service insertion for the inter-device traffic group.

In some embodiments, the TGW is a shared TGW in which the TGW does not have or is not capable of providing or creating its device group identifier as a tag for the re-originating data traffic route that it creates upon learning of the originating device group data traffic route. The TGW, in this instance, is configured to preserve the outbound device-specific group identifier (e.g.) that it learns. Since the TGW does not have a specific device group identification that it creates, the corresponding re-originating route that is created is subject to the same filtering on the outboard that is based on the device group identification (i.e., the original data route tag or identifier that has been sent) by the routing controller, and the re-originated routes are only sent to devices in the same device groups. Hence, even though the TGW is shared for all devices, it would still operate or behave in a manner that is similar to that of multiple dedicated TGWs that operate for each device group. This may be deemed useful in an environment or topology that includes device groups operating with a TGW and an SDCI.

Additionally, the techniques described herein may be performed by a system and/or device having non-transitory computer-readable media storing computer-executable instructions that, when executed by one or more processors, performs the method described above.

### EXAMPLE EMBODIMENTS

Techniques for implementing a variety of gateway deployment models with using of different device groupings with Transport Gateways (TGWs) together in a Software-Defined Wide Area Network (SD-WAN) are disclosed herein. The gateway modeling applies intelligent manipulation and tagging of the device groups during gateway traffic route origination and re-origination that may provide a centralized approach to managing and controlling a network, allowing for efficient traffic routing and security.

In some embodiments, the TGW is particularly useful in the case of SDCI networks, where the SD-WAN router is hosted in the physical infrastructure (POP) of an SD-WAN Cloud Interconnect (SDCI) provider and is configured to act as a TGW/hub for cloud-bound traffic. This allows for the TGW to start attracting data traffic that is destined for the cloud, thereby providing an optimal and accelerated path for branches to access the cloud.

In some embodiments, device groups for networking devices provide a topology in which each device group can have its own associated set of cloud hubs, while still allowing for a full mesh of tunnels between all the branch routes in different device groups. This ensures that branch-to-gateway traffic originating and re-originating from TGWs in both directions since they flow via the same device or set of devices from which the traffic routing originates to the respective TGWs.

In some cases, an SD-WAN includes branch routers, hub router units, and virtual hubs, each of which serves a specific purpose in the network. In some cases, an example of SD-WAN architecture enables compliance with two main requirements for optimal performance: symmetry and full mesh across all branches. The symmetry requirement may refer to the requirement that each branch router connects to only one hub router unit, and each hub router unit connects to at most one virtual hub. The full mesh requirement may refer to the requirement that each pair of branch routers can directly connect. In some cases, providing full mesh network topology is important for various applications with real-time or near-real-time processing requirements, because such a topology may provide a high degree of fault tolerance and ensure that every node is connected.

To achieve compliance with the symmetry and branch router full mesh requirements, an example SD-WAN architecture divides branch routers and hub router units into device groups, where each device group may include a subset of the branch routers and a subset of the hub routers. A device group can include any number of routers, as long as the group meets the requirements of the symmetry and full mesh topologies. For example, a device group A can include branch routers A and B, and hub routers A and B, while device group B can include branch routers C and D and hub routers C and D. No router can be part of more than one device group. In some cases, every router is part of at least one device group.

In some cases, to facilitate communication between routers, an example SD-WAN architecture uses selective transmission based on identifiers associated with traffic routes originating from each device and/or filtering of data traffic routes based on the route identifiers. A route may be a physical route or a logical (e.g., overlay) route.

In some cases, the techniques described herein include filtering route identifiers to ensure compliance with the constraints. For example, if a hub router in device group A receives a route identifier from a hub router in device group B, the hub router in device group A will not forward the route to any of the branch routers in device group A, as they are not in the same device group as the hub router in device group B. This selective filtering may ensure that traffic flows only between routers that are allowed to communicate with each other, according to their assigned constraints.

In some cases, the techniques described herein enable maintaining flow symmetry in an SD-WAN architecture. By ensuring that each branch router in the SD-WAN connects to only one hub router unit and each hub router unit connects to at most one virtual hub, the techniques described herein maintain flow symmetry. This flow symmetry ensures that traffic flows smoothly and consistently in both directions, without any disruptions to stateful services.

In some cases, the techniques described herein enhance the security and reliability of an SD-WAN by selectively filtering routes based on route identifiers. By enabling selective filtering of route identifiers, the techniques described herein may ensure that only authorized routes are sent to the gateway hub, and unauthorized routes are blocked. This may help to enhance network security and reliability by preventing unauthorized access to the SD-WAN. The filtering of routes enables granular control over which routes are allowed and which are not, thereby enhancing the security and stability of the SD-WAN architecture.

In some embodiments, a branch identifier or a data traffic route identifier can be utilized to route outbound branch traffic data. The identifier can identify data traffic routes from sets or groups of devices to be sent to a gateway hub based on the originating branch device. Also, with the distribution of branch traffic routes, techniques for symmetric routing in a software-defined wide area network (SD-WAN) may be disclosed.

TGW (Transport Gateway) is a CISCO® SD-WAN feature to create gateway hubs in an intent-based and automated fashion. The user just enables the TGW functionality on a device with a single-line configuration and from that point, it automatically starts re-originating the WAN routes that it learned back to the WAN/controller, thereby attracting all traffic towards itself and acting as a hub.

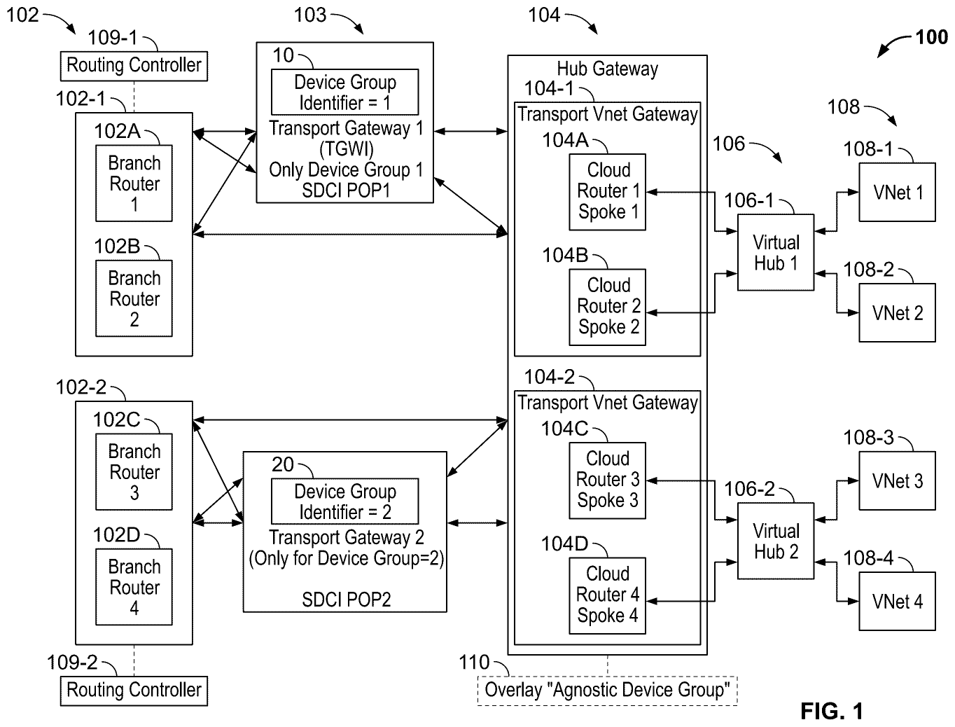

FIG. 1 is an architecture diagram for an example dedicated TGW architecture of a cloud computing framework 100 (e.g., a topology of a set of TGWs for a respective device group) of an SD-WAN system according to some embodiments. As depicted in FIG. 1, the dedicated TGW architecture of the cloud computing framework 100 includes a cloud computing framework that provides network services to a number of branch routers (102a, 202b, 102c, 102d) in respective device groups device group 1 (device group 102-1) and device group 2 (device group 102-2). The cloud computing framework 100 includes groups of routers (devices), a set of dedicated transport gateways 103 of transport gateway 1 (103-1), and transport gateway 2 (103-2) that is associated with each group of devices (102-1, 102-2), a set of gateway hub routers 104, virtual hubs 106, and virtual network hubs 108. The hub routers 104 facilitate the connection between the branch routers 104 and the virtual hubs 106. The virtual network hubs 108 connect to outside networks such as the Internet using a firewall. The virtual network hubs 108 execute operations associated with virtual routing controllers such as Cisco's vSmart controller.

In some embodiments, the TGW (103-2, 103-2) is a dedicated TGW that is configured for specific group identification. For example, the TGW 103-1 is created for the specific group identification (“Device-groups=1”), and the TGW 103-2 is created for the specific group identification (“Device-group-2”). In one instance, the TGW creates a corresponding route, a re-originating route to the device that is tagged with another or different identifier created by the TGW. In this instance, the TGW does not preserve the route identifier of the originating for use again as the re-originating route identifier, rather, the TGW creates its identifier for the returning or re-originating route that it creates in response to learning of the originating route being received.

In some embodiments, when a route is sent from a device of a particular device group, it is tagged with an identifier of a device group route and sent to a routing controller. For example, an originating route from the device 102A of device group 102-1, may be tagged with the identifier “device-group=1” and filtered by the routing controller 109-1 for distribution to the hub router 104 (e.g., transport Vnet gateway 104-1). In some instances, the routing controller 109-1 may advertise or broadcast one or more originating routers with the identifier “device-group=1”. In some embodiments, the routing controller 109-1 will send the route to other devices in the devices (e.g., inter-device between devices (branch routers 102a to 102b)) of the device group (from which it originated), in this case, device group 1 or it may send the route in an overlay 110 that is device group agnostic.

In some embodiments, a symmetrical device group of device group 2 may operate and may include a routing controller 109-2 that likewise filters and distributes corresponding originating routes with the device group identifier “device-group=2”. In some embodiments, the routing controller 109-2 will send the route to other devices in the devices (e.g., inter-device between devices (branch routers 102c to 102d)) of the device group (from which it originated), in this case, device group 2 or it may send the route in an overlay 110 that is device group agnostic.

The devices of the groups of routers (branch routers (102a, 202b, 102c, 102d)) may be located at remote sites and connect to the cloud computing framework to perform network services such as routing, security, and application optimization. The branch routers (102a, 202b, 102c, 102d) can be implemented using various hardware or software-based solutions, such as Cisco Integrated Services Routers (ISRs) or other similar devices.

The virtual hubs 106 may be cloud-based network entities that provide centralized network services and connectivity to the branch routers 102. The virtual network hubs 108 may be implemented as virtual machines or containers running in a cloud environment such as Microsoft Azure, Amazon Web Services (AWS), or Google Cloud Platform. The virtual network hub 108 can host multiple gateways such as a site-to-site virtual private network (VPN) gateway, an ExpressRoute gateway, a point-to-site gateway, and an Azure firewall.

Also, firewalls may be installed and provide security services to the virtual network hubs 108 and the virtual hubs 106. The firewalls may be implemented as virtual machines or cloud services such as an Azure Firewall, Amazon Web Services (AWS) Security Groups, or a Google Cloud firewall. The firewalls may be configured to allow or deny traffic between the virtual network hubs 108 and the virtual hubs 106 and to filter traffic based on predefined security policies.

The virtual hubs 106 may provide connectivity between the virtual network hubs 108 and other cloud resources such as virtual machines, cloud services, and storage. The virtual hubs 106 may be implemented as network segments or subnets in a cloud environment and can be configured with different internet protocol (IP) address ranges, security policies, and routing configurations.

The hub routers 104 may provide connectivity between the branch routers 102 and the virtual network hub 108. The hub routers 104 may be implemented as virtual machines or physical devices such as Cisco Cloud Services Routers (CSRs) and may be deployed in the same cloud environment as the virtual network hubs 108 (e.g., in the cloud computing framework 100). The hub router 104 may be configured with routing policies, VPN configurations, and security policies to ensure secure and reliable connectivity between the branch router(s) 102 and the virtual network hub(s) 108.

The virtual routing controllers of the virtual hub 1 (106-1) and the virtual hub 2 (106-2) may include controllers such as Cisco's vSmart controller and may provide centralized management and orchestration of an SD-WAN. The virtual routing controllers may be implemented as virtual machines or containers running in the cloud environment and may be responsible for configuring the routing policies, VPN configurations, and security policies for the virtual network hubs 108 and the hub routers 104. The virtual routing controllers of the virtual network hubs (108-1, 108-2, 108-3, 108-4) may also monitor the network performance, dynamically adjust the routing policies, and perform traffic engineering to optimize the network performance.

Alternative SD-WAN architectures can include hybrid cloud deployments where some network services are provided by on-premises hardware or software-based devices, or by third-party cloud services. Another alternative can be a fully decentralized architecture where each branch router acts as a standalone SD-WAN device without relying on centralized network services or controllers.

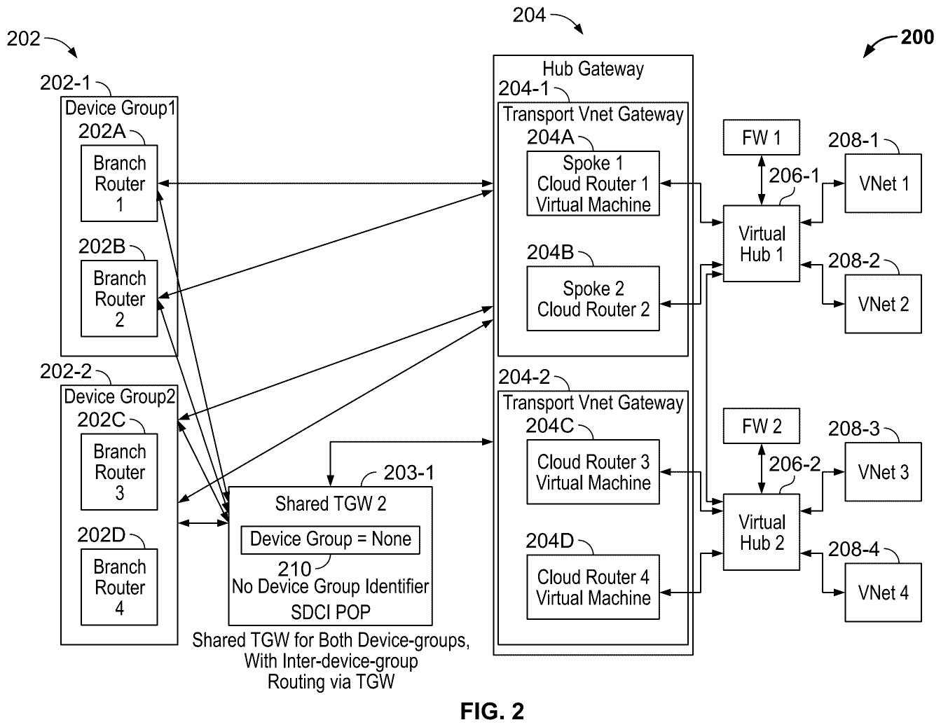

FIG. 2 is an architecture diagram for an example of shared TGW architecture of a cloud computing framework (e.g., SD-WAN architecture 200 of a topology of a shared TGW with inter-device group routing of respective device groups) of an SD-WAN system according to some embodiments. In FIG. 2, a shared TGW, in this case, the shared TGW 203-1 (TGW2) is employed to learn routes from all devices of all the device groups. In order to accomplish this learning agnostic operation, the TGW 203-1 is configured without a device group identification so the routing controllers 209-1, and 209-2 do not distribute originating routes from the respective devices of each group based on a device group identifier and sends all the originated data traffic routes directly to the shared TGW 203-1.

Referring to FIG. 2, FIG. 2 depicts an example topology that implements a shared TGW in an SD-WAN architecture 200 that includes a number of branch routers and virtual hubs, connected by hub router units. The branch routers 202 of the first device group 202-1 and a second device group 202-2 are examples of branch routers 102 of the first device group 102-1 and the second device group 102-2 of FIG. 1 and may be implemented in the same or similar way.

Each branch router 202A, 202B, 202C, and 202D of each device group, device group 1 (202-1), and device group 2 (202-2) is connected to the shared TGW 203-1 and respective could routers (e.g., virtual machines (VMs)) of the hub gateway 204. For example, branch router 1 (202A) and branch router 2 (202B) are connected to the transport vnet gateway 204-1 which is composed of cloud router 204A, and cloud router 204B. Likewise, branch router 3 (202C), and branch router 4 (202-D) are connected to the transport vnet gateway 204-2 which is composed of cloud router 204C, and cloud router 204D. Hence, the branch routers 1-2 and the branch routers 3-4 are symmetrically coupled to the transport Vnet gateways (204-1, 204-2) of the hub gateway 204.

In some embodiments, the TGW 203-1 is configured to receive the data traffic routes from all the device groups, in this case, the device groups 202-1 and 202-2 because it is not configured with the device group identification that would subject the data traffic routes to be filtered when sent. The TGW 203-1 can learn of data traffic routes from a device (e.g., a branch router) in each one of the device groups 202-1, and 202-2. For example, the TGW 203-1 may learn of a route from either branch router 1 or 2, from device group 202-1 or may learn of a route from either branch router 2 or 3 of device group 2 (202-2) (e.g., from all of the device groups without filtering by a routing controller to the TGW 203-1).

The TGW 203-1 based on the learned data traffic route, creates a complementary opposing or corresponding re-originating route and resets the device group identification tag in the re-originated route. As a result, the device group re-originated route that is created by the shared TGW 203-1 because it now has a different tag than the originated route from the device groups 202-1, and 202-2, will not be subject to the same filtering as the originated route identification is subjected too. The re-originated routes may be distributed by the TGW to devices in all device groups. This will cause the shared TGW 203-1 to attract data traffic and act as a gateway for routes from all the device groups (e.g., device groups 1 and 2), and the gateway may be considered a gateway for inter-device group traffic that allows similar service insertion for the inter-device traffic group.

In an embodiment, the Shared TGW 203-1 for all device groups has been configured with the option to do inter-device-group routing so that the same TGW 203-1 can serve multiple device groups and can route traffic across device-groups (for a hub-and-spoke model). This topology may be deemed more cost-effective and efficient in the case that traffic volume is not expected to be high.

Each set of hub routers (e.g., transport vnet gateway(s) 204-1, 204-2) of the hub gateway 204 is connected to a single virtual hub 206-1, 206-2 and includes a set of hub routers. For example, hub routers 204A and 204B are connected to the single virtual hub 1 (206-1), and hub routers 204C and 204D are connected to the single virtual hub 2 (206-2). The hub routers 204A-204D may be examples of the hub routers 104 of FIG. 1 and may be implemented in the same or similar way. Each hub router set is responsible for connecting the branch routers to the virtual hubs. The hub routers within the hub router sets may perform packet forwarding and routing.

The virtual network hubs 208 may be examples of the virtual network hubs 108 of FIG. 1 and may be implemented in the same or in a similar way. Each virtual hub may be connected to one or more other virtual hubs and one hub router set. The virtual hubs may provide centralized management of the SD-WAN and perform network services such as firewalling, load balancing, and traffic optimization. The virtual hubs may execute virtual routing controllers, such as Cisco's vSmart controller, to determine the best path for data traffic to travel through the network.

The virtual network hubs 208-1, 208-2, 208-3, and 208-4 may be examples of the virtual network hubs 108-1, 108-2, 108-3, 108-4 of FIG. 1 and may be implemented in the same or similar way. The virtual networks may represent different parts of a computing framework and/or different security zones within a network. The connections between the virtual hubs and virtual networks may be managed by the virtual routing controllers running on the virtual hubs. Also, virtual routing controllers may additionally ensure that the appropriate routes are advertised and that traffic is forwarded to the correct destinations. Using a virtual routing controller to advertise routes in an SD-WAN may ensure flexible and secure communication between the branch routers and the virtual networks, allowing for efficient network operations and management.

In addition to being connected to one or more virtual networks, each virtual hub in the SD-WAN architecture 200 may also be connected to a firewall that manages the connection between the virtual hub and an external network such as the Internet. In the depicted SD-WAN architecture 200 of FIG. 2, one or more firewalls may be coupled and responsible for ensuring that traffic from the virtual hubs to the external network is secure and meets the necessary security protocols. As an example, one or more firewalls may implement a variety of security measures such as access control policies, threat detection and mitigation, and data encryption to protect against unauthorized access or data breaches. In some cases, one or more firewalls may operate as a gateway between the virtual hubs and the external network, allowing the SD-WAN architecture 200 to securely connect to and communicate with external systems and services.

In the SD-WAN architecture 200 of FIG. 2, it may be important that each branch router connects to only one hub router unit and each hub router unit connects to at most one virtual hub to ensure that the return traffic from a dangling virtual hub to a branch router that is not connected to any hub router sets travels the same path as the traffic to the dangling virtual hub from the branch router. If a branch router connects to more than one hub router set and/or if a hub router set connects to more than one virtual hub, then the traffic from the branch router to a dangling virtual hub that is not connected to any hub router units travels a different path than the traffic from the dangling virtual hub to the particular branch. This so-called “traffic asymmetry” in transmissions to and from branch routers to dangling virtual hubs can lead to disruption in stateful services of an application.

In the SD-WAN architecture 200 of FIG. 2, it may be important that branch routers are part of a full mesh network such that each pair of branch routers can directly connect to each other. In some cases, such a full mesh network provides the most efficient path for communication between any two branch routers and eliminates the need for traffic to travel through intermediate nodes.

In some cases, establishing a full mesh network among branch routers reduces latency, improves network performance, and enables faster response times. For example, in a video conferencing application where participants need to communicate in real-time with each other and any delays or latency issues could result in poor video and audio quality, if branch routers are not part of a full mesh network, traffic may have to pass through intermediate nodes, resulting in additional delays and increased latency. This could lead to poor video and audio quality, disconnections, and a poor user experience. Moreover, without a full mesh network among branch routers, communication between branch routers may be slower, and the network may experience congestion and bottlenecks, leading to increased latency and reduced network performance. This could result in a poor user experience and could also impact the performance of other applications running on the network.

In some cases, by dividing branch routers and hub router units into device groups, the SD-WAN ensures that each device group includes a subset of the branch routers and hub routers. Operations are then performed to ensure that each branch router can only send packets to the hub router units in the same device groups as the branch router and to other branch routers, while each hub router can only send packets to the branch routers in the same device group as the hub router. This ensures traffic flows in a symmetrical manner, which is necessary for the proper functioning of stateful services, such as network address translation and firewall rules.

In some cases, a device group is a collection of branch routers and hub router units that are grouped together based on certain criteria (e.g., such as geographic location, network function, or capacity). Defining device groups may help ensure network symmetry and flow symmetry, which may be essential for maintaining optimal network performance and avoiding disruptions to stateful services such as NAT and firewall rules. By grouping routers and edge units into device groups, the SD-WAN may ensure that each branch router is connected to only one hub router set and that each hub router unit is connected to at most one virtual hub, thus satisfying the symmetry requirement. Device groups may also help satisfy the full mesh requirement by allowing each pair of branch routers to directly connect to each other within a group. This may help ensure optimal network performance and avoid disruptions to stateful services.

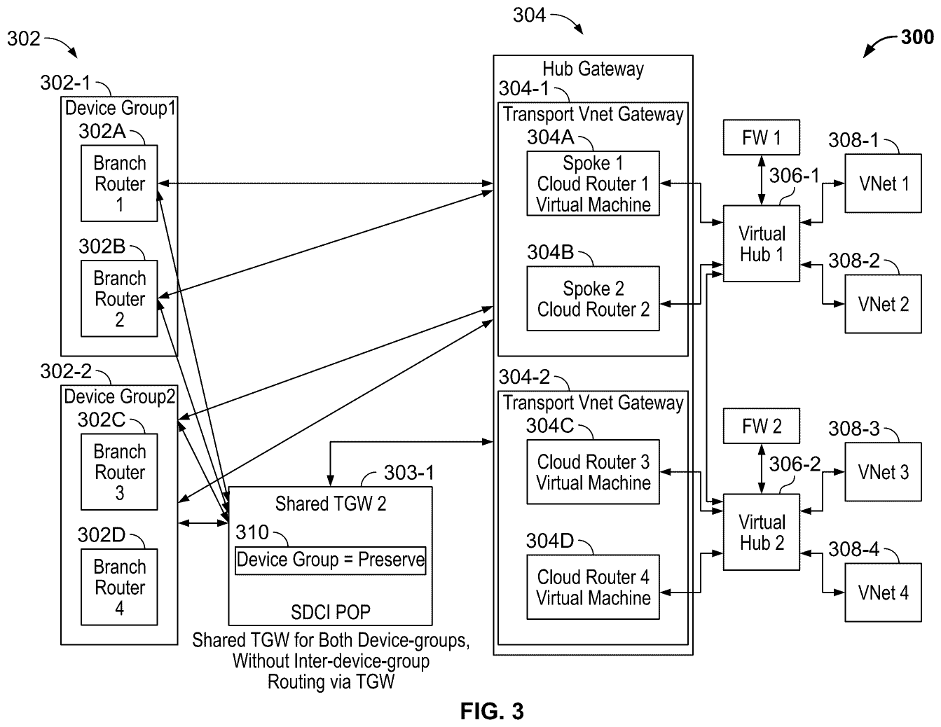

FIG. 3 is an architecture diagram for an example of shared TGW architecture of a cloud computing framework 300 (e.g., a topology of a shared TGW for both device groups without inter-device group routing) of an SD-WAN system according to some embodiments. In FIG. 3, the shared TGW 303-1 is deployed for all device groups between the device groups 302 and hub gateway 304, but without the option to be enabled for inter-device-group routing by the TGW 303-1. In FIG. 3, the same shared TGW 303-1 as in FIG. 2 is implemented to serve multiple device groups (e.g., device groups 1 and 2), but it is configured to not route data traffic across each device group (e.g., across the device groups 1 and 2). Instead, the devices 302A, 302B, 302C, and 302D in each device group (302-1, 302-2) are configured to use the shared TGW 303-1 for accelerated cloud access only.

Referring to FIG. 3, the TGW 303-1 is not configured with its own device group identifier 310 (e.g., device group=none). For example, the TGW 303-1 is not enabled to have or create its own device group identifier 310 as a tag for the re-originating data traffic route (e.g., the complementary data traffic routing that it creates). When the TGW 303-1 creates the re-originated route upon learning of the originating device group data traffic route, rather than the TGW 303-1 creating a new route identifier, the TGW 303-1 is configured to preserve the outbound device-specific group identifier that it learns and use it as its route identifier for the re-originated route (complementary route) that is created by the TGW 303-1. Since the TGW 303-1 does not have a specific device group identification that it creates, the corresponding re-originating route that is created is subject to the same filtering on the outboard that is based on the device group identification (i.e., the original data route tag or identifier that has been sent) by the routing controller, and the re-originated routes are only sent to devices in the same device groups.

Hence, even though the TGW 303-1 is shared for all devices of the device group 302, it would still operate or behave in a manner that is similar to that of multiple dedicated TGWs that operate for each device group. This may be deemed useful in an environment or topology that includes device groups operating with a TGW and an SDCI. Since the re-originated routes are now tagged with the specific device group identifier of the original received routes, the re-originated routes are subjected to outbound filtering based on device group identifier 310 in the routing controller and are sent only to devices in the same device group. As a result, even though the TGW is shared for all device groups, it still behaves like multiple dedicated TGWs for each device group. This helps tremendously in topologies involving device groups together with TGW and SDCI.

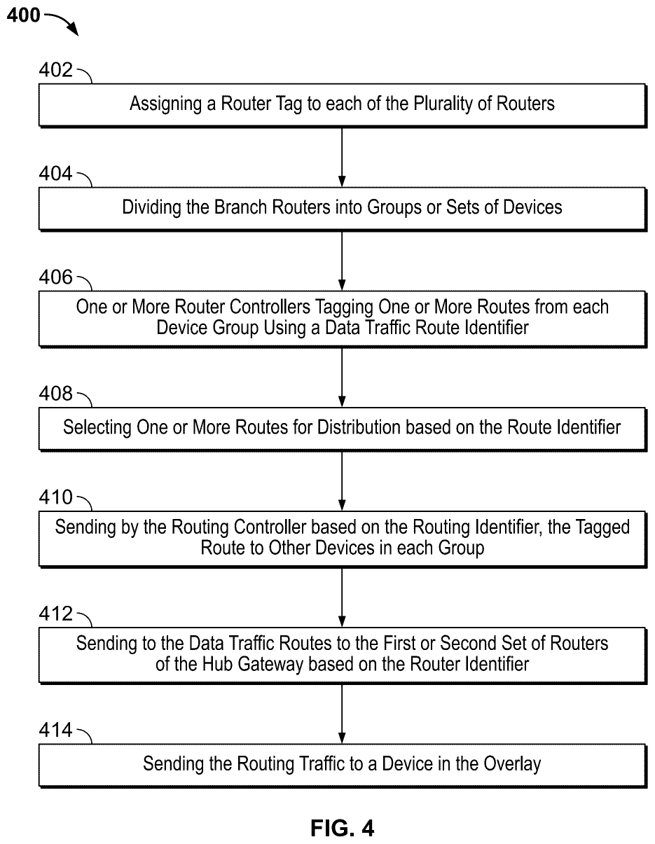

FIG. 4 is a flowchart diagram of an example process 400 for selectively sending data traffic routes originating from at least one device of a group of devices to a dedicated transport gateway (TGW) and to a gateway hub according to some embodiments. each device group has a set of dedicated TGWs that serve only that device group. This allows for better capacity planning and provides better and more deterministic throughput when the traffic volume is high.

In some embodiments, the filtered data traffic routes originated from a plurality of branch routers of an SD-WAN, and one or more routing controllers determine whether to select a route to transmit a route advertisement to one or more hub routers of an SD-WAN. The process 400 may be performed by one or more virtual routing controllers (e.g., one or more virtual routing controllers operating on one or more virtual hubs) associated with the SD-WAN.

As depicted in FIG. 4, at operation 402, process 400 includes assigning a router tag to each of the plurality of routers in the SD-WAN. A tag of a router may represent whether a data traffic route originates from a hub router or a branch router. In some cases, a hub router is associated with a “hub” tag. In some cases, a branch router is associated with a “branch” and/or a “spoke” tag.

At operation 404, process 400 includes dividing the routers of the SD-WAN into device groups. In some cases, a device group is a collection of branch routers and hub router units that are grouped together based on certain criteria (e.g., such as geographic location, network function, or capacity).

At operation 406, process 400 includes tagging by one or more routing controllers one or more data traffic routes with an identifier associated with the device from which the route originates to identify the route origination device.

At operation 408, the tagged identifier will allow for the selection and the distribution of one or more routes from a device group to a particular or dedicated TGW and subsequently to a gateway hub. For example, the routing controller may tag a first data traffic route of a first device of a first device group, and tag another or second data traffic route of a second device of a second device group. In embodiments, the first data traffic route may be identified based on its tagged identifier (e.g., a first device group identifier) and selectively distributed to a first TGW that is dedicated to data traffic routes from a first set of devices. Likewise, a second data traffic route may be identified based on its tagged identifier and selectively distributed to a second TGW that is dedicated to data traffic routes from a second set of devices.

At operation 410, process 400 includes sending, by the routing controller, the tagged data traffic route originating from at least one device of the first group of devices based on the first identifier to other devices in the first group of devices. Also, at operation 410, process 400 may include similarly sending, by the routing controller, the tagged data traffic route originating from at least one device of the second group of devices based on the second identifier to other devices in the second device group.

At operation 412, process 400 includes filtering, by the routing controller, the tagged data traffic based on the first identifier for distributing to the first TGW and the first set of routers of the hub gateway. Also at operation 412, process 400 may include similar filtering, by the routing controller, the tagged data traffic based on the second identifier for distributing to the second TGW and the second set of routers of the hub gateway.

At operation 414, process 400 includes sending, by the routing controller, the tagged data traffic route originating from at least one device of the first group of devices based on the first identifier to at least one device configured in an overlay of a group of agonistic devices. Also, at operation 414, process 400 includes sending, by the routing controller, the tagged data traffic route originating from at least one device of the second group of devices based on the second identifier to at least one device configured in an overlay of a group of agonistic devices.

As described in process 400, the routing controller will filter route distribution based on the device group identifier present in the route. When a route sent from a device in a particular device group is tagged to a particular device group (e.g., the route is identified with the particular device group), and the tag (identifier) is sent to the routing controller, the routing controller may or will be constrained to only perform the operations of sending the route to other devices in the particular device group or will be sent to devices in the overlay that is deemed to be device group agnostic (e.g., receptive to routes from any device groups and not limited to a particular identifier based device group).

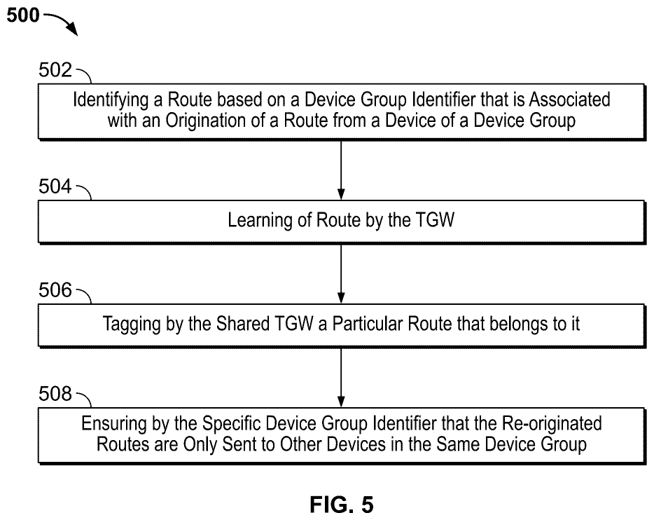

FIG. 5 is a flowchart diagram of an example process 500 in which a shared TGW is configured with a local configuration that constricts or enables operation of the TGW use of a particular specific device group identifier when the TGW learns about a route from a branch router according to some embodiments. In embodiments, the TGW may be configured to determine whether to transmit a route advertisement for a route to a source router associated with the route based on learning of a route received and by learning a device group identifier associated with the learned route.

At operation 502, process 500 includes identifying a route based on a device group identifier that is associated with an origination of a route from a device of a device group. For example, each device group will have a device group identifier that is associated with the device (e.g., the branch router from which the route originates). For example, a route from a device of a first device group will have a device group identifier that is equal or matches to an identifier configured for either a first device group or a second device group.

At operation 504, the process 500 when the shared TGW learns of a Wide-area network (WAN) route (e.g., WAN protocols that include packet over SONET/SDH (POS), Multiprotocol Label Switching (MPLS), ATM, and Frame Relay) based on a specific device group identifier that has been created for the route. In other words, the shared TGW learns the specific device group identifier of a particular route upon the learning of the route. This learning can trigger the shared TGW to create a complementary route such as a re-originated route from the shared TGW to the originating device.

At operation 506, process 500 along with or at the time of the route creation, tags by the shared TGW, the route with a specific device group identifier that belongs to the shared TGW. The device group identifier created and tagged to the route may be considered by the shared TGWs to be its own device group identifier (as opposed to the specific device group identifier created or originating from a device of the device group). In other words, the shared TGW creates and is used for tagging the re-originated route with a specific device group identifier.

At operation 508, process 500 includes ensuring by the specific device group identifier that the re-originated routes are only sent to other devices in the same device group because of a filtering operation that occurs in the routing controller when sending the route to the branch routers. In an embodiment, the routing controller's routing sending operation may be considered to be applying a constraint to the re-originated route creation to ensure that the re-originated route created by the shared TGW is sent based on a specific device group identifier to a particular device in a device group.

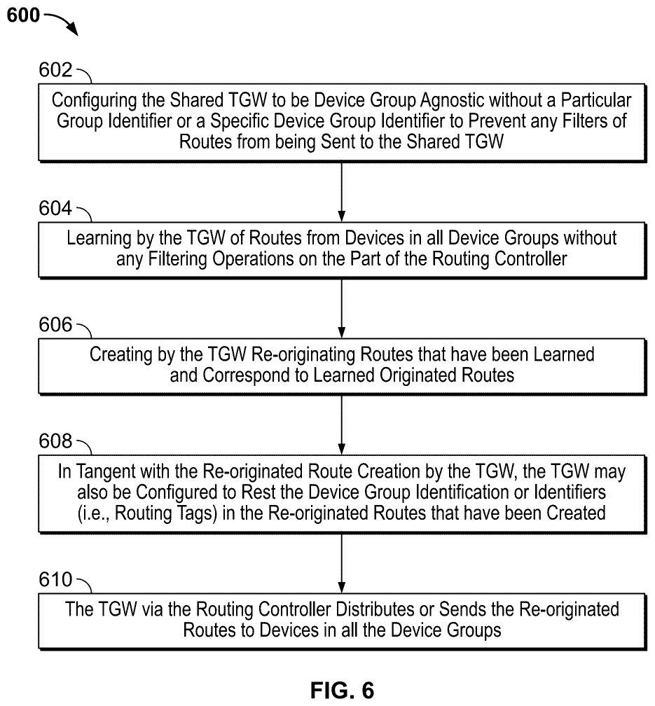

FIG. 6 is a flowchart diagram of an example process 600 in which a shared TGW is configured without a device group identifier to prevent filtering of learned routes by the shared TGW that have been routed by the routing controller according to some embodiments.

At operation 602, process 600 includes locally configuring the shared TGW to be device group agnostic without a particular group identifier or a specific device group identifier to prevent any filters of routes from being sent to the shared TGW. In other words, the shared TGW is configured to operate to accept any routes that are being routed to the TGW and the routes are not subject to filtering based on a device group identifier by the routing controller when received.

At operation 604, process 600 includes learning by the TGW of routes from devices in all device groups without any filtering operations on the part of the routing controller. As the TGW is not configured with a device group identification or identifier, no filtering can be performed by the routing controller, and therefore it may be considered that the routing controller has been implicitly prevented from applying a constraint to filtering of routes being routed to the shared TGW (e.g., the routing controller performs routing operations with a lack of any routing selections or constraint).

At operation 606, process 600 includes creating by the TGW re-originating routes that have been learned and correspond to learned originated routes.

At operation 608, the process 600 in tangent with the re-originated route creation by the TGW, the TGW may also be configured to reset the device group identification or identifiers (i.e., routing tags) in the re-originated routes that have been created. This resetting operation may occur at the time of creating the re-originating routes or the re-originated routes may be pre-configured with tags or identifiers in a reset state. The resetting of the previous device group identifiers or tags enables the re-originated routes to avoid being filtered based on the prior device group identifiers or tags.

At operation 610, the process 600, the TGW via the routing controller distributes or sends the re-originated routes to devices in all the device groups. In other words, the shared TGW attracts traffic from all the devices and acts as a subsequent gateway for routing routes from all device groups to devices within all device groups. This route routing to all individual devices in all the respective device groups may be considered an inter-device group traffic flow of sending traffic to each device in the respective device groups. This flow of inter-device group traffic enables amongst other things, service insertion for inter-device group traffic by the sharing of the traffic to each device in a device group. Therefore, the traffic that was not previously shared between one or more devices of a device group can now be shared inter-device between one or more devices in a device group.

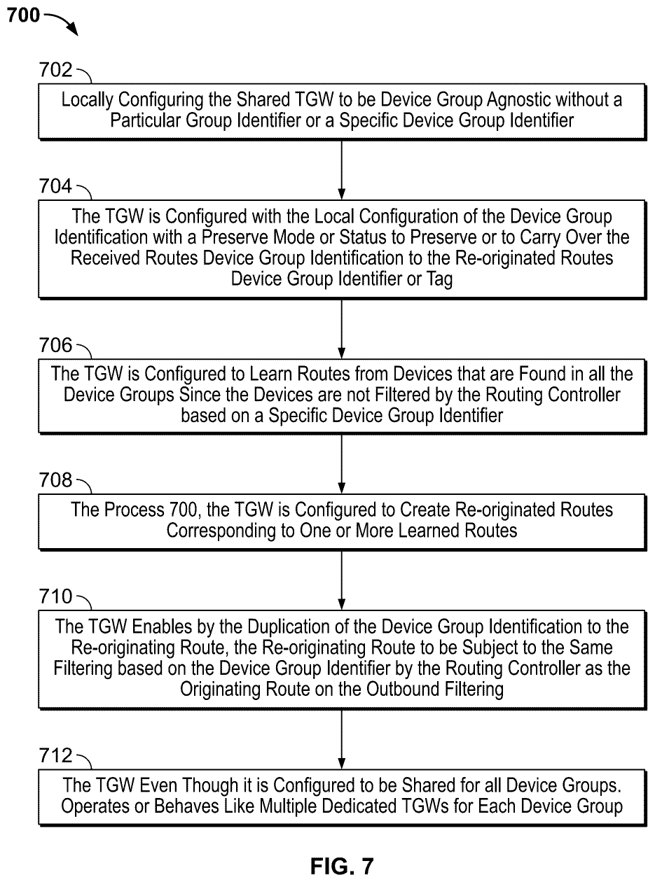

FIG. 7 is a flowchart diagram of another example process 700 in which a shared TGW is configured without a device group identifier to prevent filtering of learned routes by the shared TGW that have been routed by the routing controller but is configured to preserve the prior device group identification for reusing in re-originated created routes according to some embodiments.

At operation 702, process 700 includes locally configuring the shared TGW to be device group agnostic without a particular group identifier or a specific device group identifier to prevent any filters of routes being sent to the shared TGW in a similar process to described in FIG. 6 but in this instance, the shared TGW is configured to be locally configured to preserve or retain the previously sent device group identification to the TGW from the branch routers.

At operation 704, the process 700, the TGW is configured with the local configuration of the device group identification with a preserve mode or status to preserve or to carry over the received routes device group identification to the re-originated routes device group identifier or tag. In an embodiment, the preserved or carried-over device group identification or identifier may be used as the specific device group identification or identifier.

At operation 706, and process 700, the TGW is configured to learn routes from devices that are found in all the device groups since the devices are not filtered by the routing controller based on a specific device group identifier. In other words, the devices are not tagged or have not been tagged with a specific device group identifier or tag that allows for the filtering of device routes by the routing controller. The TGW is therefore able to learn all routes in every device group as no filtering is occurring by the routing controller.

At operation 708, the process 700, the TGW is configured to create as in the process of FIG. 6, re-originated routes corresponding to one or more learned routes. In addition, to the route creation of the re-originated routes based on the originated route learned by the TGW, the TGW copies or preserves the device group identifier or identification tag from the received originated route (from the branch router) to the corresponding or complementary created re-originated route. In this instance, the re-originated route may be considered tied to its complementary originated route as each route is now configured with the same device group identifier because of this copy-over process.

At operation 710, the process 700, the TGW enables by the duplication of the device group identification to the re-originating route, the re-originating route to be subject to the same filtering based on the device group identifier by the routing controller as the originating route on the outbound filtering. Therefore, each of the routes (the re-originating and originating routes) is subject to outbound filtering based on the device group identifier or identification tag in the routing controller and is each sent only to the devices that are designated in the same device group.

At operation 712, the process 700, the TGW even though it is configured to be shared for all device groups, operated or behaves like multiple dedicated TGWs for each device group. This can assist in various topologies that involve device groups that are configured together with TGWs and SDCIs.

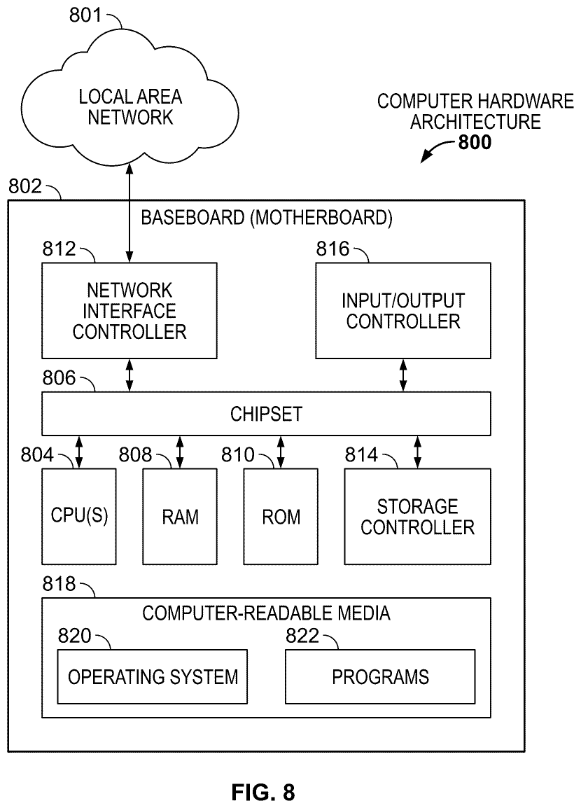

FIG. 8 shows an example computer architecture for a computing device (or network routing device) 800 capable of executing program components for implementing the functionality described above. The computer architecture shown in FIG. 8 illustrates a conventional server computer, workstation, desktop computer, laptop, tablet, network appliance, e-reader, smartphone, or other computing device, and can be utilized to execute any of the software components presented herein. The computing device 800 may, in some examples, correspond to a physical server of a cloud computing framework of FIG. 1, a branch router 102 of FIG. 1.

The computing device 800 may be coupled to a local area network 801 and/or includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computing device 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computing device 800. The chipset 806 can further provide an interface to a computer-readable storage medium such as a read-only memory (“ROM”) 810 or non-volatile RAM (“NVRAM”) for storing basic routines that help to startup the computing device 800 and to transfer information between the various components and devices. The ROM 810 or NVRAM can also store other software components necessary for the operation of the computing device 800 in accordance with the configurations described herein.

The computing device 800 can operate in a networked environment using logical connections to remote computing devices and computer systems through a network, such as the network 824. The chipset 806 can include functionality for providing network connectivity through a NIC 812, such as a gigabit Ethernet adapter. The NIC 812 is capable of connecting the computing device 800 to other computing devices over the network 824. It should be appreciated that multiple NICs 812 can be present in the computing device 800, connecting the computer to other types of networks and remote computer systems.

The computing device 800 can be connected to a storage device 818 that provides non-volatile storage for the computing device 800. The storage device 818 can store an operating system 820, programs 822, and data, which have been described in greater detail herein. The storage device 818 can be connected to the computing device 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 800 can store data on the storage device 818 by transforming the physical state of the physical storage units to reflect the information being stored. The specific transformation of the physical state can depend on various factors, in different embodiments of this description. Examples of such factors can include but are not limited to, the technology used to implement the physical storage units, whether the storage device 818 is characterized as primary or secondary storage, and the like.

For example, the computing device 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 can further read information from storage device 818 by detecting the physical states or characteristics of one or more particular locations within the physical storage units.

In addition to the mass storage device 818 described above, the computing device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 800. In some examples, the operations performed by a cloud computing framework, and or any components included therein, may be supported by one or more devices similar to computing device 800. Stated otherwise, some or all of the operations performed by the cloud computing framework, and or any components included therein, may be performed by one or more computing devices 800 operating in a cloud-based arrangement.

By way of example, and not limitation, computer-readable storage media can include volatile and non-volatile, removable, and non-removable media implemented in any method or technology. Computer-readable storage media includes but is not limited to, RAM, ROM, erasable programmable ROM (“EPROM”), electrically-erasable programmable ROM (“EEPROM”), flash memory, or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computing device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computing device 800.

In one embodiment, the storage device 818 or other computer-readable storage media is encoded with computer-executable instructions which, when loaded into the computing device 800, transform the computer from a general-purpose computing system into a special-purpose computer capable of implementing the embodiments described herein. These computer-executable instructions transform the computing device 800 by specifying how the CPUs 804 transitions between states, as described above. According to one embodiment, the computing device 800 has access to computer-readable storage media storing computer-executable instructions which, when executed by the computing device 800, perform the various processes described above with regard to FIGS. 5-7. The computing device 800 can also include computer-readable storage media having instructions stored thereupon for performing any of the other computer-implemented operations described herein.

The computing device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computing device 800 might not include all of the components shown in FIG. 8, can include other components that are not explicitly shown in FIG. 8, or might utilize an architecture completely different than that shown in FIG. 8.

The computing device 800 may support a virtualization layer such as one or more components associated with a computing resource network.

Clause 1. A method comprising: configuring, by a routing controller, at least one data traffic route originating from at least one device of a first group of devices to a first transport gateway (TGW) and a gateway hub; tagging, by the routing controller, the at least one data traffic route with a first identifier associated with the first group of devices to send to the first TGW and to a first set of routers of the hub gateway wherein the at least one data traffic route originates from at least one device of the first group of devices; and sending, by the routing controller, a tagged data traffic route originating from at least one device of the first group of devices based on the first identifier to the first TGW and the first set of routers of the hub gateway.

Clause 2. The method of clause 1, further comprising: sending, by the routing controller, the tagged data traffic route originating from at least one device of the first group of devices based on the first identifier to other devices in the first group of devices.

Clause 3. The method of clause 2, further comprising: sending, by the routing controller, the tagged data traffic route originating from at least one device of the first group of devices based on the first identifier to at least one device configured in an overlay of a group of agonistic devices.

Clause 4. The method of clause 3, further comprising: filtering, by the routing controller, the tagged data traffic based on the first identifier for distributing to the first TGW and the first set of routers of the hub gateway.

Clause 5. The method of clause 1, further comprising: configuring, by the routing controller, at least one data traffic route originating from at least one device of a second group of devices to a second TGW and a gateway hub; tagging, by the routing controller, the at least one data traffic route with a second identifier associated with the second group of devices to send to the second TGW and to a second set of routers of the hub gateway wherein the at least one data traffic route originates from at least one device of the second group of devices; and sending, by the routing controller, a tagged data traffic route originating from at least one device of the second group of devices based on the second identifier to the second TGW and the second set of routers of the hub gateway.

Clause 6. The method of clause 5, further comprising: sending, by the routing controller, the tagged data traffic route originating from at least one device of the second group of devices based on the second identifier to other devices in the second device group.

Clause 7. The method of clause 6, further comprising: filtering, by the routing controller, the tagged data traffic based on the first identifier for distributing to the first TGW and the first set of routers of the hub gateway.

Clause 8. The method of clause 7, further comprising: sending, by the routing controller, the tagged data traffic route originating from at least one device of the second group of devices based on the second identifier to at least one device configured in an overlay of a group of agnostic devices.

Clause 9. The method of clause 1, wherein the first TGW comprises a first

dedicated TGW.

Clause 10. The method of clause 5, wherein the second TGW comprises a second dedicated TGW.

Clause 11. A method comprising: configuring a shared Transport Gateway (TGW) coupled between a set of branch routers and a hub gateway wherein the set of branch routers comprises a first group of devices and a second group of devices; learning, by the shared TGW, one or more data traffic routes that originate from at least one device of a first group of devices, or a second group of devices; in response to learning of the data traffic route that originates from at least one device of the first group of devices or the second group of devices, resetting, by the shared TGW, a device group identifier to tag a first data traffic re-originated route or a second data traffic re-originated route; and redistributing, by the shared TGW, either the first data traffic re-originated route or the second data traffic re-originated route to the first group of devices or the second group of devices.

Clause 12. The method of clause 11, wherein the first data traffic re-originated route or the second data traffic re-originated route corresponds to the first data traffic route or the second data traffic route that originated from the at least one device of the first group of devices, or the second group of devices.

Clause 13. The method of clause 12, wherein the shared TGW attracts data traffic from either the first group of devices or the second group of devices.

Clause 14. The method of clause 13, further comprising: creating, by the shared TGW, one or more re-originated routes that correspond to one or more learned data traffic-originated routes.

Clause 15. The method of clause 11, further comprising: acting, by the shared TGW, as a gateway for one or more data traffic routes that originate from either the first group of devices or the second group of devices.

Clause 16. The method of clause 15, wherein the shared TGW is not configured with a device group identifier to accept data traffic routes that originate from either the first device group of devices or the second device group of devices.

Clause 17. The method of clause 11, wherein the shared TGW is configured without a group device identifier enables the shared TGW to act as a gateway for data traffic routes from a plurality of device groups.

Clause 18. The method of clause 11, wherein one or more data traffic re-originated routes avoid being subject to outbound filtering by a routing controller based on resetting of a device group identifier to be used by the re-originated routes that enable the shared TGW to act as a gateway for inter-device group traffic between one or more devices of a device group.

Clause 19. A method comprising: configuring a shared transport Gateway (TGW) coupled between a set of branch routers and a hub gateway wherein the set of branch routers comprises a first group of devices and a second group of devices; learning, by the shared TGW, a specific device group identifier that has been tagged for a data traffic route that originates from at least one device of at least one of the first group of devices or the second group of devices; in response to learning of the data traffic route that originates from at least one device of either the first group of devices or the second group of devices, preserving, by the shared TGW, the specific device group identifier for use as an identifier of a data traffic re-originated route that is to be created by the shared TGW; and creating, by the shared TGW, the data traffic re-originated route with a specific device identifier using a preserved specific device group identifier to either the first group of devices or the second group of devices.

Clause 20. The method of clause 19 further comprising: in response to tagging of the data traffic re-originated route, filtering, by a routing controller, re-originated data route traffic being sent from at least one device of either the first group of devices or the second group of devices based on the device group identifier.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications that do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A method comprising:
configuring, by a routing controller, at least one data traffic route originating from at least one device of a first group of devices to a first transport gateway (TGW) and a gateway hub;
tagging, by the routing controller, the at least one data traffic route with a first identifier associated with the first group of devices to send to the first TGW and to a first set of routers of the hub gateway wherein the at least one data traffic route originates from at least one device of the first group of devices; and
sending, by the routing controller, a tagged data traffic route originating from at least one device of the first group of devices based on the first identifier to the first TGW and the first set of routers of the hub gateway.

2. The method of claim 1, further comprising:
sending, by the routing controller, the tagged data traffic route originating from at least one device of the first group of devices based on the first identifier to other devices in the first group of devices.

3. The method of claim 2, further comprising:
sending, by the routing controller, the tagged data traffic route originating from at least one device of the first group of devices based on the first identifier to at least one device configured in an overlay of a group of agonistic devices.

4. The method of claim 3, further comprising:
filtering, by the routing controller, the tagged data traffic based on the first identifier for distributing to the first TGW and the first set of routers of the hub gateway.

5. The method of claim 1, further comprising:
configuring, by the routing controller, at least one data traffic route originating from at least one device of a second group of devices to a second TGW and a gateway hub;
tagging, by the routing controller, the at least one data traffic route with a second identifier associated with the second group of devices to send to the second TGW and to a second set of routers of the hub gateway wherein the at least one data traffic route originates from at least one device of the second group of devices; and
sending, by the routing controller, a tagged data traffic route originating from at least one device of the second group of devices based on the second identifier to the second TGW and the second set of routers of the hub gateway.

6. The method of claim 5, further comprising:
sending, by the routing controller, the tagged data traffic route originating from at least one device of the second group of devices based on the second identifier to other devices in the second device group.

7. The method of claim 6, further comprising:
filtering, by the routing controller, the tagged data traffic based on the first identifier for distributing to the first TGW and the first set of routers of the hub gateway.

8. The method of claim 7, further comprising:
sending, by the routing controller, the tagged data traffic route originating from at least one device of the second group of devices based on the second identifier to at least one device configured in an overlay of a group of agnostic devices.

9. The method of claim 1, wherein the first TGW comprises a first dedicated TGW.

10. The method of claim 5, wherein the second TGW comprises a second dedicated TGW.

11. A method comprising:
configuring a shared Transport Gateway (TGW) coupled between a set of branch routers and a hub gateway wherein the set of branch routers comprises a first group of devices and a second group of devices;
learning, by the shared TGW, one or more data traffic routes that originate from at least one device of a first group of devices, or a second group of devices;
in response to learning of the data traffic route that originates from at least one device of the first group of devices or the second group of devices, resetting, by the shared TGW, a device group identifier to tag a first data traffic re-originated route or a second data traffic re-originated route; and
redistributing, by the shared TGW, either the first data traffic re-originated route or the second data traffic re-originated route to the first group of devices or the second group of devices.

12. The method of claim 11, wherein the first data traffic re-originated route or the second data traffic re-originated route corresponds to the first data traffic route or the second data traffic route that originated from the at least one device of the first group of devices, or the second group of devices.

13. The method of claim 12, wherein the shared TGW attracts data traffic from either the first group of devices or the second group of devices.

14. The method of claim 13, further comprising:
creating, by the shared TGW, one or more re-originated routes that correspond to one or more learned data traffic-originated routes.

15. The method of claim 11, further comprising:
acting, by the shared TGW, as a gateway for one or more data traffic routes that originate from either the first group of devices or the second group of devices.

16. The method of claim 15, wherein the shared TGW is not configured with a device group identifier to accept data traffic routes that originate from either the first device group of devices or the second device group of devices.

17. The method of claim 11, wherein the shared TGW is configured without a group device identifier enables the shared TGW to act as a gateway for data traffic routes from a plurality of device groups.

18. The method of claim 11, wherein one or more data traffic re-originated routes avoids being subject to outbound filtering by a routing controller based on resetting of a device group identifier to be used by the re-originated routes that enables the shared TGW to act as a gateway for inter-device group traffic between one or more devices of a device group.

19. A method comprising:
configuring a shared transport Gateway (TGW) coupled between a set of branch routers and a hub gateway wherein the set of branch routers comprises a first group of devices and a second group of devices;
learning, by the shared TGW, a specific device group identifier that has been tagged for a data traffic route that originates from at least one device of at least one of the first group of devices or the second group of devices;
in response to learning of the data traffic route that originates from at least one device of either the first group of devices or the second group of devices, preserving, by the shared TGW, the specific device group identifier for use as an identifier of a data traffic re-originated route that is to be created by the shared TGW; and
creating, by the shared TGW, the data traffic re-originated route with a specific device identifier using a preserved specific device group identifier to either the first group of devices or the second group of devices.

20. The method of claim 19 further comprising:
in response to tagging of the data traffic re-originated route, filtering, by a routing controller, re-originated data route traffic being sent from at least one device of either the first group of devices or the second group of devices based on the device group identifier.
